(19) United States
(12) Patent Application Publication
(10) Pub. No.: US 2021/0259379 A1
(43) Pub. Date: Aug. 26, 2021

(54) CONTAINER WITH WATERPROOF BOTTOM AND METHOD OF MAKING SAME

(71) Applicant: Neil S. LEIBOWITZ, Passaic, NJ (US)

(72) Inventor: Neil S. LEIBOWITZ, Passaic, NJ (US)

(21) Appl. No.: 16/973,366

(22) PCT Filed: Jun. 10, 2019
(86) PCT No.: PCT/US2019/036431

§ 371 Date: Dec. 8, 2020

Related U.S. Application Data
(60) Provisional application No. 62/682,584, filed on Jun. 8, 2018.

(51) Int. Cl. A45C 13/00; A45C 3/00; A45C 3/06

(52) U.S. Cl. CPC A45C 13/008; A45C 3/06; A45C 3/001

(57) ABSTRACT

A container with a waterproof bottom is disclosed wherein the bottom is made of a rubberized or rubber-like material and is attached or connected to a separate fabric or plastic panel forming the upper part of the container. In the method, a rubberized or rubber-like material product is attached separately with an adhesive, such as a rubber cement, to a base panel of a container. Also, a rubber-like material is separately attached with an adhesive to all around the sides. The rubber-like product of the sides is specially molded for this purpose and has a channel at the top of each of the sides for stitching. Further adhesive is secured through a vulcanize heating process at temperature of about 70 degrees Centigrade for a period of about 6 minutes. After the heating process the now rubberized fabric bottom panel is stitched through the specific channel in the rubber sides to the upper part.

### BACKGROUND OF THE INVENTION

Most containers, such as flexible bags, are made with bottom panels of synthetic materials that are not durable or waterproof. The bottoms of the bags are often sewn to the bottom of the bag with seams that do not block moisture and water seepage into the contents of the bag. Also, these seams are prone to separation due to the frequent use and pressure from the weight of the bag on hard surfaces, such as concrete, pavement, tile, and other abrasive surfaces. Some of the prior art bags are made with leather or leather-like materials, which themselves are not usually waterproof as a result from the nature of leather or the connecting seams. These bags are subject to accumulation on the bottom panels of wear and tear that renders them damaged or failed products within a short period of time. Stains and dirt also cannot be properly removed due to the fabric limitations, and this results in frequent replacement by the user at a reoccurring cost.

The prior art is replete with attempts to provide a physically secure, environmentally protected, yet an acceptable container or bag. Some of these include the following examples:

Kigere U.S. Design Pat. 155,811 which discloses a bottom of a bag that uses a zipper to attach it to the body of the bag;

Hyman U.S. Pat. No. 3,121,452 which discloses a handbag have a folded bottom construction that is stitched to the bag upper;

Kaplan U.S. Pat. No. 3,202,191 which discloses a compartmented bag with an attachable bottom;

Dimon U.S. Pat. No. 5,000,726 which discloses a handbag assembly utilizing a tongue and a plurality of slots to attach the bottom to the bag upper;

Gelb U.S. Pat. No. 5,676,295 which discloses a molded rubberized base for a fabric bag, such as a backpack, where the base has a bottom and sides and is connected to the fabric body portion of the backpack;

Sisitsky U.S. Pat. No. 7,900,757 which discloses a carrying bag that includes a detachable bottom portion attached with a track system;

Lewis U.S. Pat. No. 9,364,061 which discloses a bag having an expandable and reinforceable secondary storage cavity and a fastening mechanism to fasten the materials;

Cross et al. United States Patent Application Publication US2015/0336715 which discloses a flexible material bag with affixed seams that are attached using a variety of methodologies including a thermoplastic elastomer strip; and

Schenk et al. United States Patent Application Publication US2017/0022640 that discloses a knitted bag that includes a first and second overlapping layers that are knitted integrally together.

Each of the above listed references is incorporated herein by reference and forms a part of the disclosure of the present invention.

### SUMMARY OF THE INVENTION

The present invention is related to luggage, backpacks, duffel bags, utility bags, messenger bags, diaper (or Mommy) bags, cosmetic bags, tote bags, and the like. The present invention provides a solution to the problems of the prior art, and in addition provides an ease of use with function that enables the bag to stand up on its own, regardless of contents within. In addition, most users are concerned for the safety of the contents such as electronic devices, photographic equipment, laptop computers and related accessories. This concern is mitigated by the present invention which provides waterproof resistance for bags placed on water surfaces, shockproof resistance for dropped bags, and skid proof protection from sudden lateral movement of the bag on slippery surfaces.

One embodiment of the present invention is comprised of a bottom base made of a rubber-type material and a flexible fabric top portion. The rubber can be natural rubber, or a manufactured alternative. For the purposes of this application, the word “rubber” will be used to mean all types of a waterproof, rubbery material.

A major difference of the present invention over the traditional bags is that rubber as a bottom portion of the bottom of the bag replaces fabric, seams, and/or fabric bindings of ordinary assembly that has limited durability, and quickly would show wear and tear. The present production process of the present invention provides extraordinary durability for bag life cycle, the length of which may be lifetime or infinite—a length of time that, due to the unique production process—is too far into the future to predict with accuracy. Athletic shoes are subject to much greater pressures and abuse and may last for years of wear and tear. The bag according to the present invention has a rubber bottom of a type similar to an athletic shoe but is subject to only a fraction of the pressure of shoes, which suggests almost infinite durability.

However, it should be understood that the present invention does not require that all of these advantages be achieved in every process or product covered by the scope and spirit of the invention.

### BRIEF DESCRIPTION OF THE DRAWINGS

FIG. 1 is a perspective view of a tote type bag having the features of the present invention according to one embodiment in which the front side of the bag is shown transparent so that the features of the back side of the bag can be visible;

FIG. 2 is a perspective view of the upper cloth fabric part of the bag without the bottom being connected;

FIG. 3 is a top perspective view of the bottom of the bag depicted in FIG. 1;

FIG. 4 is a bottom perspective view of the bag depicted in FIG. 1;

FIG. 5 is a drawing of a cropped bottom perspective view of a prototype of one embodiment of a bag according to the present invention depicting the sewing groove in the top;

FIG. 6 is a drawing of a cropped bottom perspective view of a prototype of another embodiment of the invention;

FIG. 7 is a drawing of a side view of the entire bag of FIG. 6;

FIG. 8 is a drawing of a bottom perspective view of the bag of FIG. 6;

FIG. 9 is a drawing of a side elevational view of the bag of FIG. 6;

FIG. 10 is a drawing of a bottom perspective view of the bag of FIG. 9;

FIG. 11 is a drawing of an exploded top perspective view of the bottom of the bag of FIG. 9;

FIG. 12 is a drawing of an exploded bottom perspective view of the bottom of the bag of FIG. 9;

### DETAILED DESCRIPTION OF THE PRESENTLY PREFERRED EMBODIMENT

The present invention covers a variety of bags and processes that may be used to create modifications and alterations that are within the scope of the present invention. The selection and description of a particular bag or method is not intended to limit the scope of the invention.

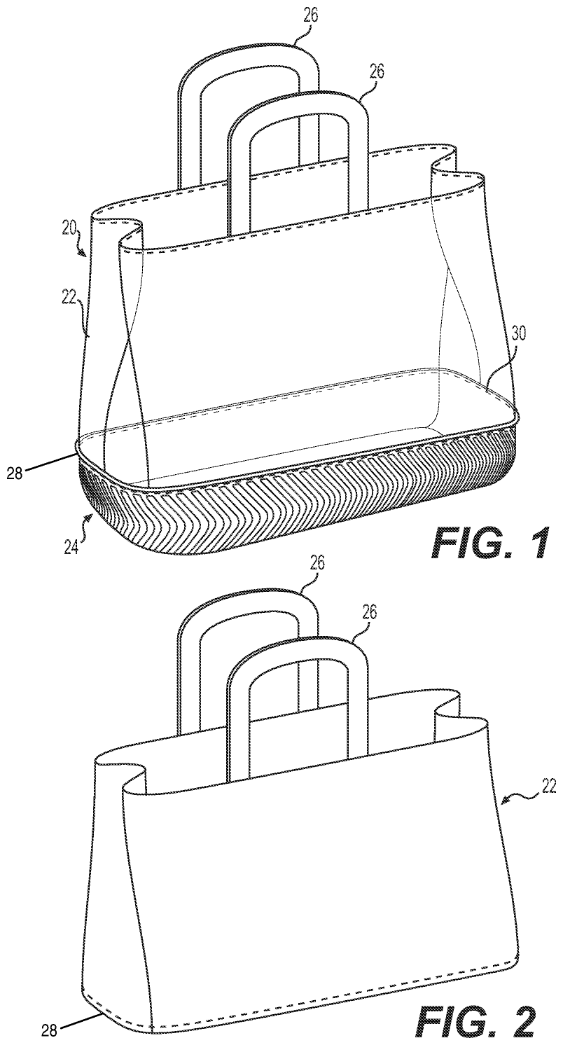

Referring now to the drawings in which like numbers represent like elements of the depicted embodiment of the invention throughout the several views, and in particular with reference to FIG. 1, a bag 20 according to the present invention is depicted. Bag 20 is a type of tote bag and is comprised of a hollow upper section 22 attached to a bottom section 24. Bottom section 24 is connected at a top portion 30 thereof to a bottom portion 28 of upper section 22. Bag upper section 22 can be made of any flexible or rigid material, such as fabric, canvas, leather, polyester, wool, and cotton. Bottom section 28 is made of a common rubbery material that includes rubber and a polyester. The basic requirement for the rubbery material is that it is capable of being vulcanized. Bottom section 24 is made separately from upper section 22.

U-shaped handles 26, preferably in the embodiment of FIG. 1 are made of cloth fabric, and are attached at their respective ends to the top of upper section 22. Handles 26 can also be leather, wood, plastic or metal. Although bag 20 is depicted in the drawings as a tote bag, it could also be luggage, backpacks, duffel bags, utility bags, messenger bags, diaper (or Mommy) bags, cosmetic bags, and the like.

Bottom section 24, as seen in FIGS. 1, 3, 4 and 5, includes a bottom surface 32 and an annular upstanding portion 34. Bottom surface 32 and upstanding portion 34 has a chevron pattern molded therein. Obviously, a different pattern could be molded in portion 34. The bottom surface 32 has a mosaic pattern molded therein, and again, a different pattern could be molded in. Bottom surface 32 and upstanding portion 34 are cemented and heat sealed together along their respective edges. The surface of upstanding portion 34 of bottom surface 32 has a chevron pattern molded therein. At top edge portion 36 of bottom section 24 is an annular recess or channel 40. Bottom section 24 is attached to upper section 22 with stitching 38 sewed into channel 40.

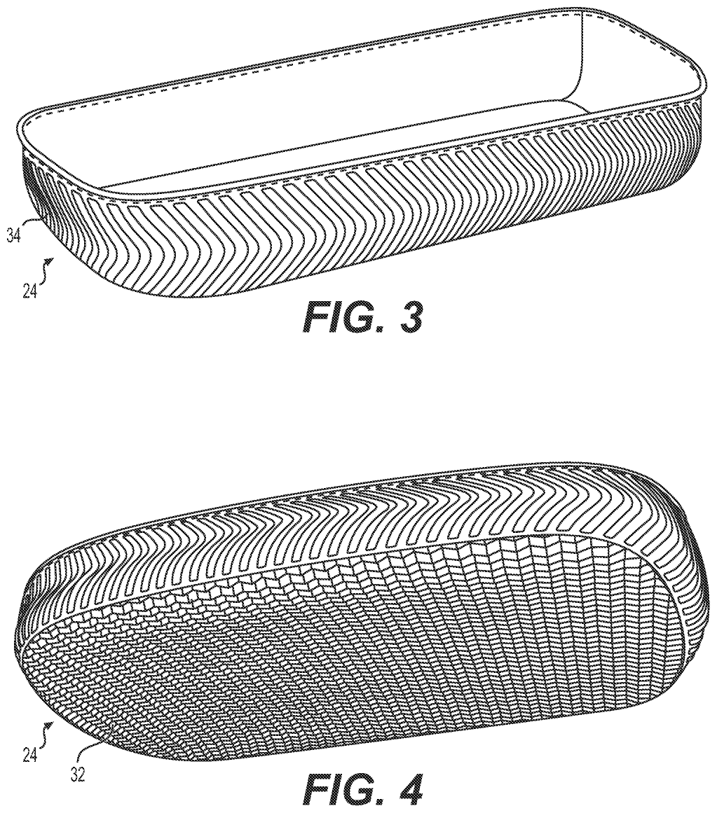

The components of the bottom section 24 of bag 20 are depicted in various stages of construction in FIGS. 3, 4, 5, 11 and 12.

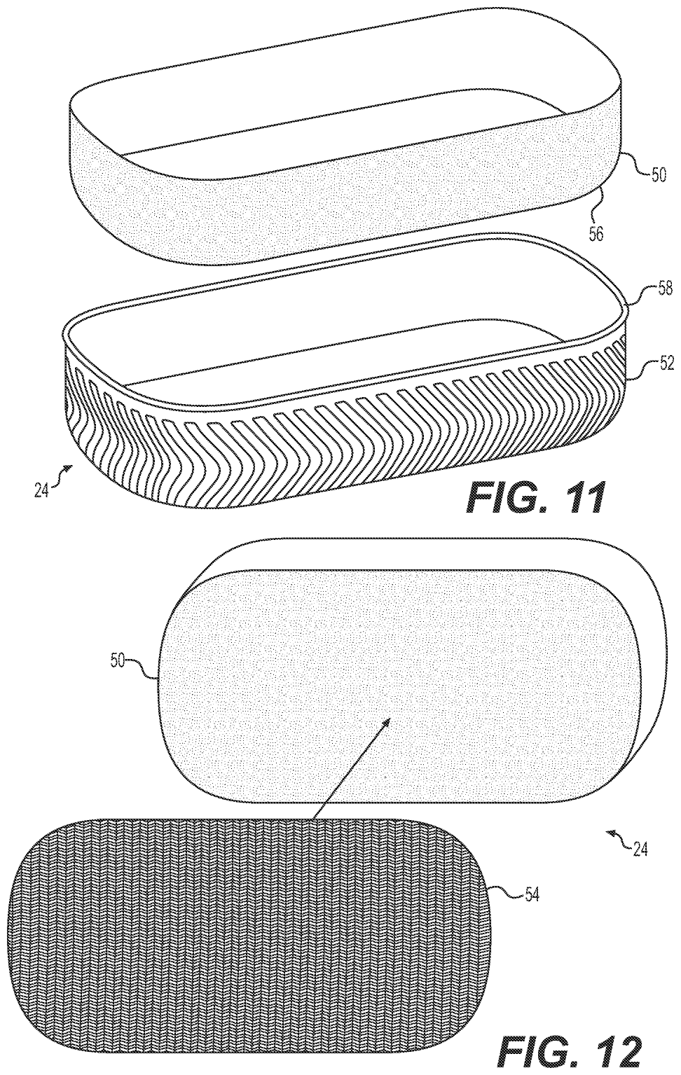

Bottom section 24 is depicted in FIGS. 11 and 12 before the components are cemented and then vulcanized. Bottom section 24 is comprised of a fabric bottom piece 50, which could be a cotton canvas, polyester or leather. Bottom section 24 is also comprised of a rubber strip 52 that has been molded and cut to fit bottom piece 50. Strip 52 has channel 40 molded into an upper part thereof. A rubber bottom panel 54 is cut to fit the size and dimensions of bottom piece 50 and cemented thereto. Piece 50 with panel 54 and piece 52 are then initially cemented or glued together to form bottom section 24 depicted in FIGS. 3 and 4.

When assembled, the bottom of strip 52 overlaps the edge of panel 54 and seals the connection. After the cement is fixed, the now one-piece bottom section 52 is placed in an oven and vulcanized for a measured amount of time, such as 10 minutes, at a standard vulcanizing temperature.

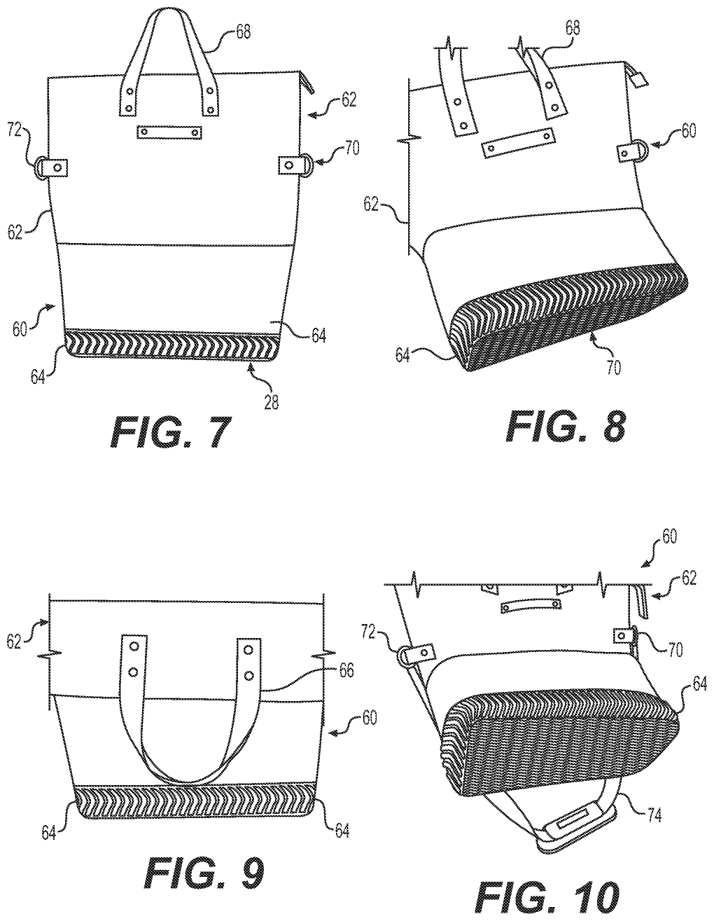

With reference to FIGS. 7-10, a bag 60 of a further embodiment having a different style is depicted. Bag 60 is comprised of an upper section made of cloth or similar flexible material, and a rubber bottom section 64. The bag 60 of FIGS. 7, 8 and 9 has handles 68 and side rings 70 and 72, for attaching a strap 74, shown in FIG. 10.

A method of making a bag having a rubberized waterproof bottom comprises a plurality of steps.

The bags are produced in two distinct parts: an upper body or section 22 and a separate base/bottom section or housing 24. Bottom section 24, as mentioned above, is made and assembled separately from the upper section 22, and then the two parts are connected together, such as by stitching 38.

Bottom section 24 is produced by inserting a complimentary shaped “last” (as in shoe terminology) into the bottom section 24. Then a strip comprised of a molded rubber having a channel 40 at a top section thereof is separately attached to the sides and bottom of the bottom panel housing with a cold cement. Bottom section 24 is then heated in a high temperature oven at conventional vulcanizing temperatures and times so as to fix or secure in place the molded rubber attachments permanently to the bottom panel housing by conventional high temperature vulcanization.

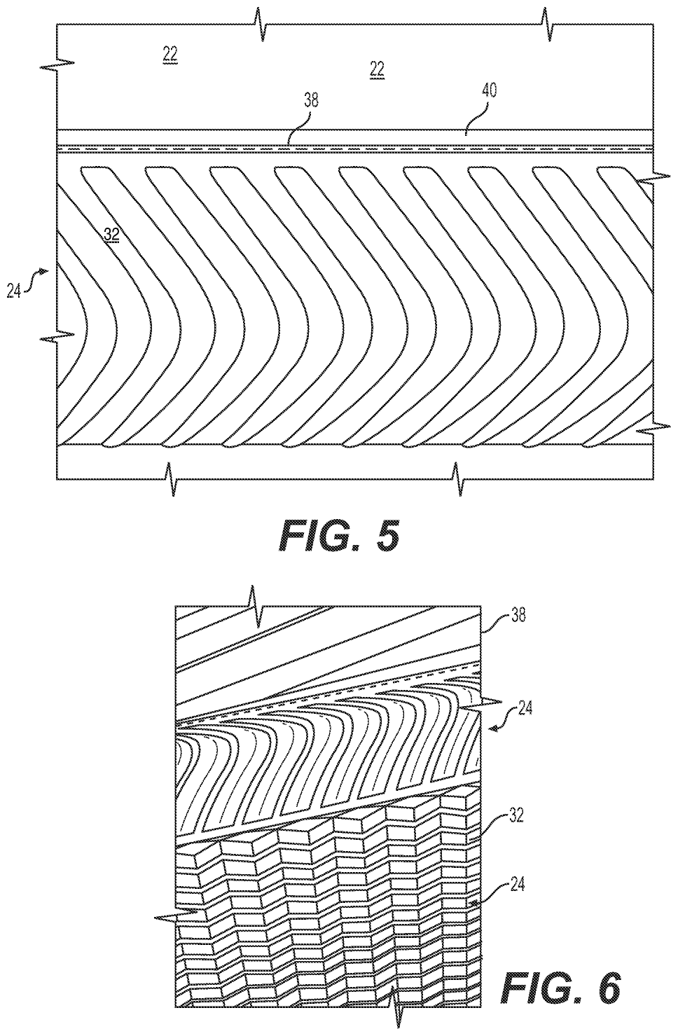

As shown in FIG. 5, the vulcanized bottom section 24 is then secured to the upper section 22 of bag 20 with stitching 38 through the channel 40 that was molded into the rubber. This specific embodiment of the process can have the various steps performed in separate locations or by separate facilities, such as a sewing factory for producing the upper section 22 and sewing the components together, and a second vulcanization factory for producing the bottom section 24, or they can be performed in a single facility with different departments, or even in the same department.

As shown in FIG. 1, the molded rubber bottom section 24 of bag 20 in this embodiment can be decorated by being debossed with a chevron or cross-hatched pattern, or any other desired pattern, such as that which is similar to that used on athletic shoes. Or, it can be debossed with any other design such as an icon of a brand or the name of a brand itself spelled out. In the shoe industry, it is known as the “Outsole,” (see strip 52 in FIG. 11). Although the outsole part resists accumulation of dirt, it is easy to clean with common, conventional cleansers should it become dirty or soiled.

The sides of the bottom section 24 are covered with rubber, known as “foxing” in the shoe production industry. This provides further durability and unique design to the bag. The outsole and foxing are attached in separate parts which are then vulcanized together to make a seamless bottom for the bag that will not allow water, moisture, dirt, or other substances through to the bag contents. All of the rubber can be coated with a glaze (i.e. “shiny”) finish which adds fashionable appearance and further resistance to the accumulation of dirt and grime. Further, strip 52 can be debossed with any other design, such as an icon of a brand or the name of a brand spelled out.

As may be readily appreciated by those skilled in the manufacture of bags or of the design of the bags themselves, the present invention can be practiced other than as is specifically disclosed herein. Thus, while the present invention has been described generally and with respect to certain preferred embodiments, it is to be understood that the foregoing and other modifications and variations may be made with departing from the scope or the spirit of the present invention.

1. A container with a waterproof bottom comprised of:
a hollow main body having an upright wall that encloses a space inside of the wall, said wall having a top part and a bottom part; and
a bottom made of a waterproof material having a bottom portion and a side portion, the side portion having a top area and a bottom area, wherein said side portion top area overlaps said bottom part of said wall, and has a channel therein around the side portion of said top area, and stitching in said channel connecting said bottom to said bottom part of said body so as to form the enclosed space.

2. The container as claimed in claim 1 wherein said main body portion is made of a flexible material.

3. The container as claimed in claim 2 wherein said material is selected from the group consisting of a woven fabric, canvas, leather, polyester, wool, and cotton.

4. The container as claimed in claim 1 wherein said main body portion is made of a rigid material.

5. The container as claimed in claim 1 wherein said bottom section is made of a common rubbery material that includes rubber and a polyester.

6. A method of making a container with a waterproof bottom comprised of the following steps in any order:
making an upper body of a flexible material having a bottom portion so as to produce a hollow section therein, and
making a separate bottom section of the same or another flexible material;
providing a molded base of a rubber-like material having a bottom panel and integral encircling upstanding sides, said sides having a channel in an outer upper portion of said sides;
attaching the bottom section to the molded base;
placing a last that has a shape complimentary to the bottom section onto the bottom section onto the bottom section;
vulcanizing the rubber-like material to form a unitary bottom having an upper portion,
removing said last;
inserting the bottom portion of said upper body into the upper portion of said unitary bottom; and
stitching the upper portion of said unitary bottom to the bottom portion of said upper body through the channel.

7. The container as claimed in claim 1 and further including a material lining inside of the bottom portion.

8. The container as claimed in claim 7 wherein said material lining is of the same type of flexible material out of which said main body part is made, said material selected from the group consisting of fabric, polyester, woven fabric, canvas, leather, wool, and cotton.

9. The container as claimed in claim 1 and further including foxing that is cemented on the outside of side portion of the container.

10. The container as claimed in claim 1 wherein said bottom section is comprised of a bottom fabric piece.

11. The container as claimed in claim 10 and said bottom section further includes a rubber bottom panel that has been cut to fit bottom fabric piece and has been cemented thereto.

12. The container as claimed in claim 10 wherein said bottom section has been vulcanized.

13. The method of making a container as claimed in claim 6, and further comprising attaching foxing to the upstanding sides of said molded base.

14. The method of making a container as claimed in claim 6 wherein a diameter of said upstanding sides is slightly larger than a diameter of said upper body so that said upper body can fit inside said upstanding sides.

15. A method of making a container with a waterproof bottom comprised of the following steps in any order:
making an upper body of a flexible material having an upper section;
providing a molded rubber-like material having two parts, a bottom part and an upstanding side part encircling said bottom part, said upstanding side part having a channel in an upper portion thereof;
placing a complimentary shaped last onto the bottom panel;
attaching to said bottom part a flexible material with an adhesive;
vulcanizing the rubber-like material so that said bottom part is attached to said upstanding side part;
inserting the lower section of the upper body into the vulcanized bottom part; and
stitching the bottom panel to the upper body through said channel.
